(19) United States
(12) Patent Application Publication
(10) Pub. No.: US 2012/0248962 A1
(43) Pub. Date: Oct. 4, 2012

(54) COMPACT FLUORESCENT TUBE FOR COLD SPACES

(75) Inventor: Hans Mårtensson, Sturko (SE)

(73) Assignee: Auralight International AB, Karlskrona (SE)

(21) Appl. No.: 13/394,519

(22) PCT Filed: Aug. 31, 2010
(86) PCT No.: PCT/SE2010/050928

§ 371 Date: Jun. 15, 2012

(30) Foreign Application Priority Data
Sep. 16, 2009 (SE) 0950676-7

(51) Int. Cl. H01J 61/52

(52) U.S. Cl. 313/47

(57) ABSTRACT

The present invention relates to a compact fluorescent tube (1) designed for cold spaces, which compact fluorescent tube (1) comprises at least one fluorescent tube body (13) formed into a U-shape and comprising two fluorescent tube body legs (17), which latter have an interspace (19) between them and each comprise a base part (9), enclosing a cathode chamber (11), and a top part (15) facing away from the said base parts (9), which base parts are fixed to a socket part (3), comprising current feeder members (5) for electrical contact with the cathode chambers (11). An insulating member (21, 47, 55) is arranged on the top part (15) of the compact fluorescent tube and is configured with at least one insulating cavity (23, 49), which, during operation of the compact fluorescent tube (1), is heated by the self-produced heat of the compact fluorescent tube (1).

### TECHNICAL FIELD

The present invention relates to a compact fluorescent tube designed for cold spaces, according to the preamble to Patent Claim 1, and to an insulating member, according to the preamble to Patent Claim 11.

The invention relates to compact fluorescent tubes of the low and high frequency type, designed to be able to deliver the greatest possible quantity of light into an ambient environment having a temperature lower than room temperature. By compact fluorescent tubes is here meant fluorescent tubes which are formed into a U-shape, in constellation around a tube, double tubes or three tubes, or configured with parallel fluorescent tube body towers interconnected by a bridge. Compact fluorescent tubes of this kind have a common socket and a common current feeder member and can replace the conventional incandescent lamp. By cold spaces is meant spaces which are colder than room temperature, such as cold stores and freezing rooms.

The invention relates to the manufacturing industry for the manufacture of fluorescent tubes.

### BACKGROUND ART

At present, oblong fluorescent tubes having a socket at the respective end of the fluorescent tube are used in cold spaces. These fluorescent tubes are provided with an outer tube for realizing a heat-insulating air gap between the fluorescent tube and the outer tube. In this way, the light flux from the fluorescent tube into cold spaces is improved. Straight fluorescent tubes of this kind can also be placed in elongated, U-shaped plastics hoods in the cooling space. See, for example, US 2007/210687 A1, which describes this. Without any insulating gap, the fluorescent tube is too cold during operation and acquires a mercury vapour pressure which is altogether too low. The light flux from a fluorescent source is heavily dependent on the temperature in which the latter operates.

At present, so-called compact fluorescent tubes comprising a socket provided with one or more U-shaped fluorescent tubes are found, in which both ends of the respective fluorescent tube are directed in the same direction, that is to say towards the socket and the current feeder member. The actual bottom of the U-shape is thus constituted by a curve of the fluorescent tube body, which curve is facing away from the socket. The U-shaped fluorescent tubes on one and the same socket make the compact fluorescent tube (the lamp) less bulky, which is advantageous in cold spaces.

There are compact fluorescent tubes having screw sockets, wherein the entire fluorescent tube bodies are covered by a glass bulb reproducing the impression of a traditional incandescent lamp. Compact fluorescent tubes of this kind are not insulated during operation and often have a working life which is altogether too short. Nor, therefore, are they used in cold spaces.

### SUMMARY OF INVENTION

The need persists to be able to make the lighting source less bulky in cold spaces, such as refrigerators and freezers, at the same time as the energy efficiency is maintained in comparison with compact fluorescent tubes during operation at room temperature.

Traditional compact fluorescent tubes acquire more and more fields of application by virtue of their space-saving configuration. If a traditional compact fluorescent tube is used in a cold space, such as a refrigerator, the light flux, however, is impaired.

One way of meeting this requirement is to use compact fluorescent tubes with high power consumption, which is seen to be costly.

The object of the invention is thus to provide a compact fluorescent tube which can be used in cold spaces and which delivers there a satisfactory light flux.

The object is also to be able to manufacture a compact fluorescent tube for cold spaces in a cost-effective manner.

The object is likewise to provide a compact fluorescent tube which is designed for cold spaces and has a long working life.

The object is also to provide an insulating member which a consumer or user can easily apply to a traditional compact fluorescent tube, thus can be effectively used in a cold space in non-bulky arrangement and with satisfactory light flux.

A further object of the invention is to eliminate drawbacks of the prior art.

### DISCLOSURE OF INVENTION

The abovementioned objects have been achieved by means of the compact fluorescent tube defined in the introduction and having the characteristics specified in the characterizing part of Patent Claim 1.

In this way, a compact fluorescent tube can be used in cold spaces with maintained satisfactory light flux, at the same time as the light source can be non-bulky.

The mercury vapour pressure in a fluorescent light source is determinant of the light flux from the same. The mercury vapour pressure is determined by the temperature in the coldest region of the light source, which region is affected by the ambient temperature. The light flux is dependent on the ambient temperature.

The mercury vapour pressure in the compact fluorescent tube in a cold space can thus be maintained and the light flux is approximately the same as if the compact fluorescent tube is used at room temperature. Since the mercury vapour pressure can be maintained simply and with small material consumption by suitable insulation of the top part of the compact fluorescent tube, the energy transformation of the mercury to the UV wavelength 253.7 nanometres (the UV wavelength 253.7 nanometres is converted in luminescent materials of the fluorescence tube to visible light) is able to be realized. The present Applicant has discovered by experimentation that the coldest region of the compact fluorescent tube is precisely the top part of the compact fluorescent tube and is the part which primarily needs to be insulated in order to maintain the mercury vapour pressure. The Applicant has found that the mercury vapour pressure is determined by the temperature in the coldest region of the light source, which region is affected by the ambient temperature, and that the light flux is dependent on the ambient temperature.

Alternatively, the insulating member is constituted by a transparent hood enclosing the compact fluorescent tube, so that a gap constituting the cavity is formed between the said fluorescent tube body and the hood.

In this way, a narrow gap of 1-4 mm, preferably 2-3 mm, can be realized between the hood and the fluorescent tube body/bodies, as well as a gap between the fluorescent tube body legs of the fluorescent tube bodies, which gaps contain air which is heated during operation of the compact fluorescent tube. The air in the gaps is thus heated during operation and the coldest region which determines the mercury vapour pressure acquires an increase in temperature. The transparent hood also ensures that the light flux can flow without hindrance from the light source to the cold space, for example the interior of the refrigerator.

Expediently, the hood is made of plastic.

At the same time, an impact-resistant compact fluorescent tube, which is advantageous when, for example, hard frozen food products are stowed in a freezer, is thereby realized. A plastics hood is likewise cost-effective to make.

Alternatively, the hood consists of at least two hood halves, each extending in the longitudinal direction of the fluorescent tube body legs and interconnected by at least one connecting element.

The hood can thereby be fitted in a cost-effective manner, wherein the hood halves can comprise as connecting elements irreversible rivet joints, cast in plastic, which extend through the U-shaped fluorescent tube body, that is to say between the fluorescent tube body legs of the fluorescent tube body and close to the curve and/or bridge of the fluorescent tube body. The hood hence does not slide off the fluorescent tube body when handled. Where the number of fluorescent tube bodies is three and the compact fluorescent tube then comprises six fluorescent tube body legs, the hood can alternatively consist of three halves extending in the longitudinal direction of the fluorescent tube body legs. These three halves can be coupled together in a similar manner, but by means of, for example, two irreversible rivet joints. A bridge is defined as a hollow glass body, which connects two fluorescent tube bodies to each other so that plasma, during operation of the compact fluorescent tube, can be transported between the different fluorescent tube bodies.

Expediently, the insulating member extends towards the socket part to the extent that an open space is formed between the socket part and the insulating member.

A compact fluorescent tube, which gives a satisfactory light flux in cold spaces, has thus been realized, which compact fluorescent tube can be manufactured in a cost-effective manner with low material consumption. The open space between the socket part and the insulating member, such as a hood, is realized to avoid contact between the hood and the socket, which gets very warm during operation. The hood does not in that case need to be glued to the socket, which would otherwise be critical due to the said heat and mechanical fracture. The hood, and hence also the compact fluorescent tube as a whole, would otherwise acquire a shorter working life through blackening of the hood within the region of the base part. When the said hood is used, a rod which, as the connecting element, secures the hood to the fluorescent tube body, can preferably be arranged between two fluorescent tube body legs, which rod is fixed in the inner wall of the hood on opposite sides, extending between the fluorescent tube body legs. Preferably, the rod extends through a “keyhole” which can be shaped on the curve of the fluorescent tube body in the interspace between the fluorescent tube body legs (inside curve). In this way, the hood is held in place without the need to be glued to the socket. Nor is the hood affected by the higher generated heat at the socket and at the base part. The hood remains transparent and does not become black due to contact with the socket or the base part.

Alternatively, the U-shaped fluorescent tube body of the compact fluorescent tube, on its curved portion (or bridge), is manufactured with a wider portion of the interspace between the fluorescent tube body legs in the top part, compared to the width of the interspace generally between the fluorescent tube body legs. Passing through this wider portion in the top part, the said connecting element, which, for the formation of the said air-containing gap, secures and orientates the hood suitably on the fluorescent tube body, is fitted during manufacture of the compact fluorescent tube.

Expediently, a safety mantle made of insulating material extends between the insulating member and the socket part.

In this way, a safety function has been realized in a cost-effective manner. In the event of possible damage to the fluorescent tube body, shattered or broken glass does not fall from the compact fluorescent tube, which is advantageous in freezers for the storage of food.

Alternatively, the insulating member is constituted by a plug having a plurality of the said cavities, which plug, when the number of U-shaped fluorescent tube bodies is two or more, is insertable between the fluorescent tube bodies in the top part.

In this way, a simple insulating member has been realized, which can be fitted in a cost-effective manner to the top part of the compact fluorescent tube during manufacture. The insulating member per se can be produced in a simple manner by extrusion. The configuration of the plug can alternatively comprise a widening in that end of the plug which, during manufacture, is first inserted between the fluorescent tube bodies. The widening is configured to engage in the interspace between the fluorescent tube body legs of at least one of the fluorescent tube bodies once the upper part of the plug bears against the top parts of the fluorescent tube bodies and the plug is in position for insulation of the top parts.

Expediently, the plug is made of foamed silica.

Silica (SiO2), which is a very good and stable insulator, is thus used for the plug. A very large energy-saving potential is obtained by a material which mostly consists of air and a little silica. The plug gives greatly increased energy efficiency when this insulating material is used. The silica is transparent and tolerates more than 500° C. without change. The silica plug can be cost-effectively cast into suitable shape, in which 3-5% is pure natural material, SiO2 (silica). The rest of the volume of the plug can be air, which insulates.

Alternatively, the insulating member is an insulating transparent gel, which has been applied directly to the fluorescent tube body within the region of the top part.

The structure of a transparent insulation in the form of a gel offers the prospect of a being able to manufacture compact fluorescent tubes for cold spaces in a cost-effective manner by dipping the top part of the fluorescent tube body into the said gel during the production. The gel comprises a large quantity of small cells and the material can be made of a number of different plastics, for example carbonate plastic or Teflon.

Expediently, the insulating member comprises a connecting member for securing the insulating member to the fluorescent tube body via the said interspace.

In this way, the insulating member in the form of a hood or plug can be fastened to the fluorescent tube body/bodies in a simple manner without the insulating member needing to be fastened directly to the socket. The connecting element or the said connecting pin can be made of injection-moulded plastic and can constitute irreversible rivet joints, which extend through the U-shaped fluorescent tube body, that is to say between the fluorescent tube body legs of the fluorescent tube body. Alternatively, the connecting pin can be in two parts and can enclose a bridge between two fluorescent tube bodies in order to secure the insulating member to the fluorescent tube body/bodies.

The abovementioned objects have also been achieved by means of the insulating member defined in the introduction and having the characteristics specified in the characterizing part of Patent Claim 11.

A consumer can thus augment a traditional compact fluorescent tube with an insulating member, allowing the compact fluorescent tube also to be used in an energy-efficient manner in cold spaces. The consumer can easily insert the insulating member in the top part, or can easily fit the insulating member as two or more hood halves, mutually connected by connecting elements in the form of pins or rods which snap into one another and which rest in the interspace between the fluorescent tube body legs, expediently to the bridge or curve of the fluorescent tube body, against the inner side thereof.

Alternatively, the insulating member is a transparent hood.

An insulating member which is easy to fit for a consumer is thereby provided.

Expediently, the insulating member is constituted by a plug insertable in the top part.

An insulating member which is easy to fit for a consumer is thereby provided.

Alternatively, the top part is enclosed by a UV-resistant, heatproof and transparent plastics film, forming an insulating cavity by means of the thereby created insulated gap between the fluorescent tube bodies within the region of the top part.

In this way, by production engineering methods, an insulating cavity can be realized in a cost-effective manner in the top part by winding of the plastics film around the fluorescent tube bodies, wherein the fluorescent tube bodies serve as supports for the insulating film and the gap between the fluorescent tube body legs forms the said cavity.

### BRIEF DESCRIPTION OF DRAWINGS

The invention will now be explained with reference to the drawing, in which, in schematic representation:

FIG. 1a shows a compact fluorescent tube for cold spaces according to a first embodiment;

FIG. 1b shows the compact fluorescent tube in FIG. 1a from the side;

FIG. 2 shows the fluorescent tube body of the compact fluorescent tube in FIG. 1a;

FIGS. 3a-d show a compact fluorescent tube for cold spaces according to a second embodiment;

FIG. 4 shows in perspective a compact fluorescent tube for cold spaces according to a third embodiment;

FIG. 5 shows a compact fluorescent tube for cold spaces according to a fourth embodiment;

FIG. 6 shows a compact fluorescent tube for cold spaces according to a fifth embodiment;

FIGS. 7a-b show a compact fluorescent tube for cold spaces according to a sixth embodiment;

FIGS. 7c and 8 show the insulating member shown in FIGS. 7a-7b;

FIG. 9 shows in perspective a compact fluorescent tube for cold spaces which comprises the insulating member shown in FIG. 8;

FIG. 10 shows in perspective a compact fluorescent tube for cold spaces according to a seventh embodiment; and

FIG. 11 shows a cross section through two fluorescent tube bodies enclosed by an insulating film within the region of the top part of the compact fluorescent tube for cold spaces according to an eighth embodiment.

### MODE(S) FOR CARRYING OUT THE INVENTION

The invention will be described in detail with the aid of embodiments. For the sake of clarity, components which are immaterial to an explanation of the invention have been omitted in the drawing. The embodiments should not be deemed to limit the invention, but are merely examples.

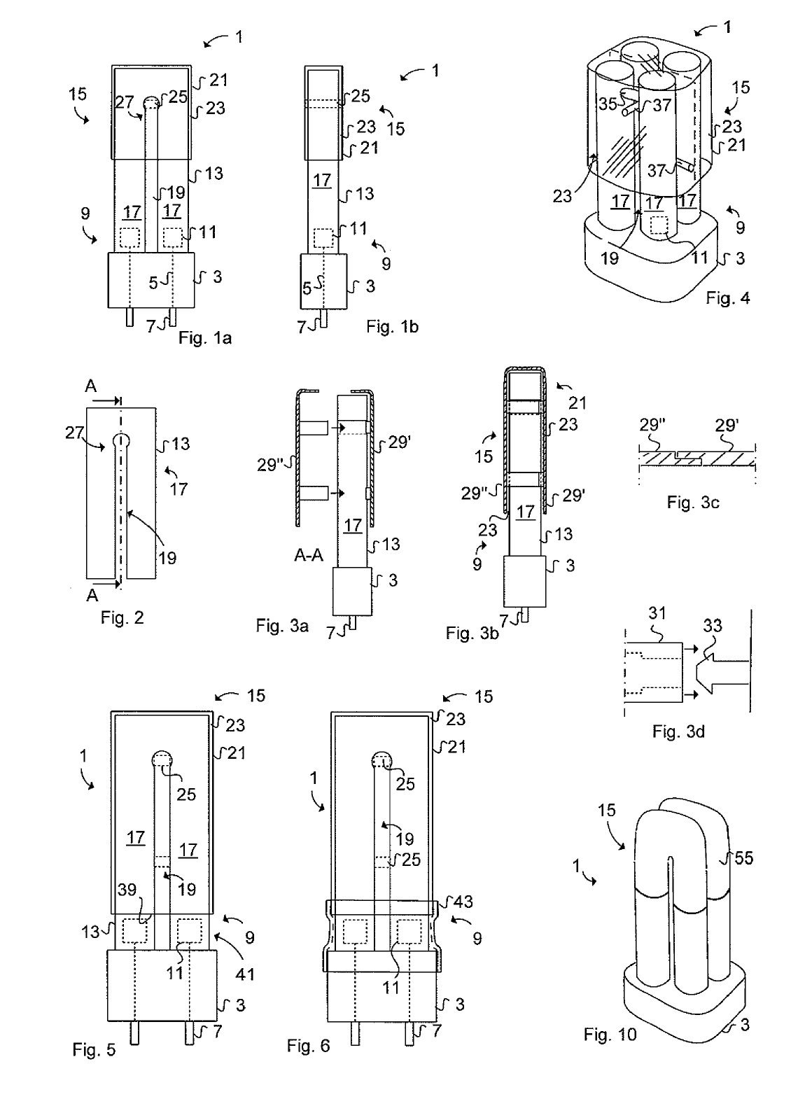

FIG. 1a shows schematically, from the front, a compact fluorescent tube 1 for cold spaces (not shown) according to a first embodiment.

The compact fluorescent tube 1 comprises a socket 3, containing current feeder members 5 connected to contact pins 7, and a cathode chamber 11, arranged in each base part 9, each cathode chamber comprising an electrode (not shown). The current feeder member 5 is designed for electrical contact with the cathode chambers 11. The compact fluorescent tube 1 further comprises a fluorescent tube body 13. The fluorescent tube body 13 is made up of respective base parts 9, facing towards and coupled to the socket 3, and a top part 15, in which the fluorescent tube body 13 curves and plasma, during operation, turns 180 degrees in direction. The top part 15 is situated opposite the socket 3 of the compact fluorescent tube 1 and facing away from the said base parts 9. The fluorescent tube body 13 is thus defined by a top part 15 and base parts 9 and is curved through 180 degrees to form two fluorescent tube body legs 17. The fluorescent tube body legs 17 extend side by side in parallel, with an interspace 19 between them.

An insulating member in the form of a hood 21 is arranged on the top part 15 of the compact fluorescent tube 1 and is configured with at least one insulating cavity 23, which, during operation of the compact fluorescent tube 1, is heated by the self-produced heat of the compact fluorescent tube 1.

The greatest heat is generated at the socket 3 within the region of the base parts 9 and the mercury vapour pressure is here sufficient to realize a satisfactory quantity of light, since the electrodes in the cathode chamber 11 produce plasma during operation of the compact fluorescent tube 1. In the cold space, experiments have shown that the top part 15 is critical, in terms of the temperature, to realizing an appropriate mercury vapour pressure.

In FIG. 1b, the compact fluorescent tube 1 in FIG. 1a is shown schematically from the side. Here a connecting element in the form of a rib 25 (dashed line) is shown, which rib extends between and is fixed to the walls of the hood 21. The rib 25 extends through the upper portion 27 of the interspace 19 within the region of the top part 15. The upper portion of the interspace 19 is wider than the rest of the width of the interspace and is configured in the shape of a keyhole, shown in greater detail below in FIG. 2. The rib 25 has a thickness corresponding to the greatest width of the upper portion or keyhole, so that the rib engages in the upper portion 27. In this way, the hood can be held in place. In the manufacture and fitting of the hood, the rib 25, once the hood 21 is in correct position, is pushed through holes (not shown) made in the walls of the hood 21 and is welded in place in the hood 21.

The hood 21 is transparent and is made of plastic. The hood 21 encloses the compact fluorescent tube 1 such that a gap (constituting the cavity 23) is formed between the fluorescent tube body 13 and the wall of the hood 21. The cavity 23 is also constituted by the space which is formed by the interspace 19 of the fluorescent tube body legs 17 within the region of the hood 21 and the wall of the hood 21.

In FIG. 2, the fluorescent tube body 13 of the compact fluorescent tube 1 in FIG. 1a is shown following manufacture of the fluorescent tube body 13. The fluorescent tube body is manufactured under heat and the glass of the fluorescent tube body is curved into the desired shape. In the forming, the upper portion 27 is realized with a keyhole shape.

FIGS. 3a-3d show a compact fluorescent tube 1 for cold spaces according to a second embodiment, but in which a fluorescent tube body 13 corresponding to that for the first embodiment is used for the compact fluorescent tube 1. The section A-A in FIG. 2 is shown in FIG. 3a, in which the fluorescent tube body 13 has a socket 3 fixed to the fluorescent tube body 13. A first hood half 29′ comprising two irreversibly mountable pins 31 is fitted to the fluorescent tube body 13 so that the pins 31 extend through the interspace 19 between the fluorescent tube body legs 17. After this, a second hood half 29″ is fitted against the first hood half 29′, wherein the pins 31 engage in corresponding pins 31 of the second hood half 29″ and lock the hood halves 29′, 29″ one against the other. The hood halves 29′, 29″ extend in the longitudinal direction of the fluorescent tube body legs 17.

In FIG. 3b, the two hood halves 29′, 29″ are shown in position forming a hood 21 enclosing the top part 15 of the fluorescent tube body 13, wherein the pins 31 are irreversibly coupled. The edges of the hood halves 29′, 29″ engage in one another in overlapping arrangement through stepped bevelling, in the manner shown in FIG. 3c. In FIG. 3d, the ends of the pins 31, constructed for irreversible fitting, are shown in schematic representation, wherein a knob 33 of hook-shaped configuration is inserted into a recess in the opposite pin 31 and snaps in place.

FIG. 4 shows schematically in perspective a compact fluorescent tube 1 for cold spaces according to a third embodiment. The compact fluorescent tube 1 is made up of two fluorescent tubes having a cathode chamber 11 in each. A bridge 35 (only one is shown) connects two fluorescent tube body legs 17 in the region of the top part 15 of each fluorescent tube. Four fluorescent tube body legs 17 or “towers” are thus fixed to the socket 3. Connecting elements in the form of rods 37 extend between the internal walls of the hood 21. The rods 37 are in engagement with and clamp against the bridges 35 so as to secure the hood 21 to the fluorescent tube bodies 17 in such a way that a cavity 23 is formed between “the towers” per se and between “the towers” and the hood 21 within the region of the top part 15. During operation in a cold space having a temperature of +8 degrees Celsius, such as a refrigerator (not shown), this cavity 23 is heated by the compact fluorescent tube 1 by virtue of the self-produced heat of the compact fluorescent tube 1. The thereby heated cavity 23 raises the temperature of the compact fluorescent tube 1 in the top part 15. The top part 15 is the coldest part of the compact fluorescent tube 1 and, through such heating of the top part 15, the mercury vapour pressure for the fluorescent tube bodies 17 can be raised. In this way, the light flux from the fluorescent tube bodies 17 can be maintained at the same level as produced by a traditional compact fluorescent tube operated at room temperature. An energy-efficient compact fluorescent tube for cold spaces, which is less bulky than traditional fluorescent tubes, has thus been realized. The bridge 35 is defined as a hollow glass body which connects two fluorescent tube bodies 17 or “towers” one to another, so that plasma (not shown), during operation of the compact fluorescent tube 1, can be transported between the different fluorescent tube bodies 17. The rods 37 are in two parts and enclose the bridges 35 in order to secure the hood 21 to the fluorescent tube bodies 17. In the course of assembly, the rods 37 snap into one another and rest in the interspace 19 of the fluorescent tube body legs 17 against the bridges 35.

FIG. 5 shows schematically a compact fluorescent tube 1 for cold spaces according to a fourth embodiment. According to this embodiment, the fluorescent tube body 13 corresponds to the configuration shown in FIG. 2. A hood 21 is arranged on the top part 15 of the compact fluorescent tube 1 and is configured in such a way that an insulating cavity 23 is realized between the fluorescent tube body 13 and the hood 21, which cavity 23, during operation of the compact fluorescent tube 1, is heated by the self-produced heat of the compact fluorescent tube 1. The hood 21 also comprises a portion which extends down towards the socket 3 and a bit over the base part 9 of the fluorescent tube body 13, so that an open space 41 is formed between the socket 3 and the lower edge 39 of the hood 21 (the edge of the hood 21 around the opening of the hood 21). The space 41 between the socket 3 and the edge 39 is realized to avoid contact between the hood 21 and the socket 3, which latter becomes very warm during operation. In that respect, the hood 21 does not need to be glued to the socket 3, which would otherwise be critical due to the said heat and mechanical fracture. The hood 3, and hence also the compact fluorescent tube 1 as a whole, would otherwise acquire a shorter working life through blackening of the hood 21 within the region of the base part 9. Securement of the hood 21 to the fluorescent tube body 13 is realized by means of the ribs 25, which in FIG. 5 extend in the direction orthogonal to the paper of the drawing and between the fluorescent tube body legs 17 in the interspace 19.

FIG. 6 shows schematically a compact fluorescent tube 1 for cold spaces according to a fifth embodiment. A safety mantle 43, in the form of a heatproof flexible hose, is fitted on the socket 3 and connects to the lower part of the hood 21 within the region of the base part 9. The safety mantle 43 is not in contact with the fluorescent tube body 13 and is made of an insulating material extending between the hood 21 and the socket 3. A safety function has thus been realized in a cost-effective manner. In the event of possible damage to the fluorescent tube body 13, shattered or broken glass does not fall from the fluorescent tube body 13 down into the freezing compartment, which is advantageous in freezers for the storage of food.

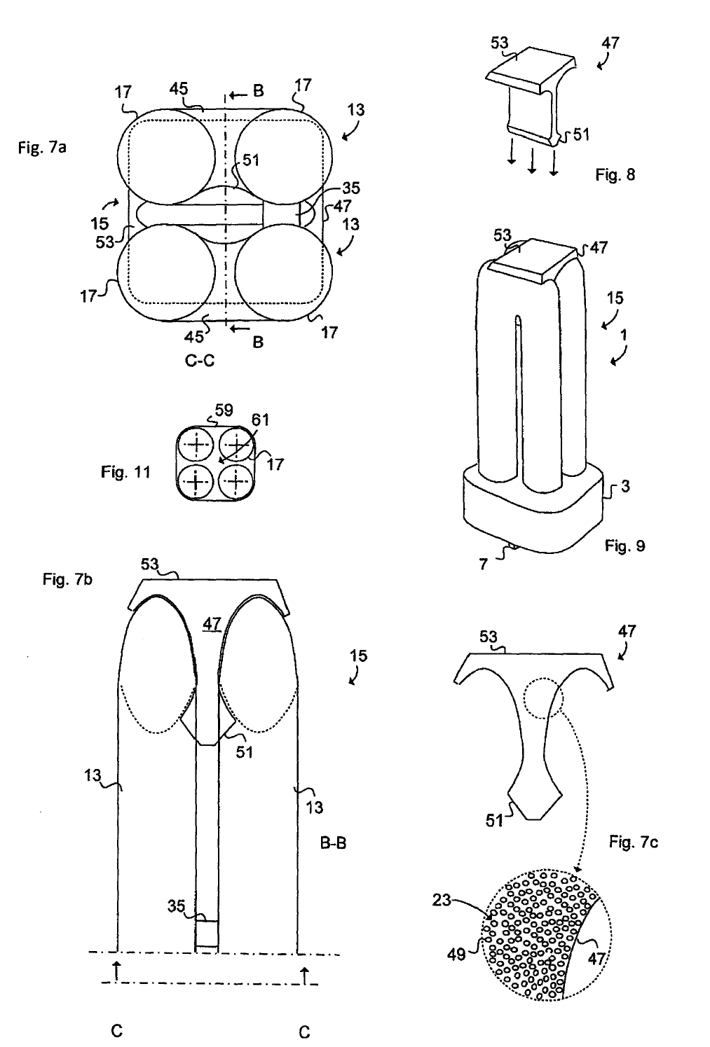

FIGS. 7a-7b show schematically a compact fluorescent tube 1 for cold spaces according to a sixth embodiment. FIG. 7a shows the compact fluorescent tube 1 from below in a cross section C-C taken transversely to the compact fluorescent tube shown in section B-B from the side in FIG. 7b. The number of fluorescent tube body legs 17 is four in number and belongs to two fluorescent tube bodies 13. The curve 45 of each fluorescent tube body 13 in a U-shape is thus shown from below. A plug 47 insertable between the fluorescent tube bodies 13 in the top part 15 is fitted into the top part 15 for insulation of the top part 15. The plug 47 has a plurality of air-filled pores 49 acting, like a number of cavities 23, in an insulating manner, which is shown in greater detail in FIG. 7c. As shown in FIG. 7b, the plug 47 comprises a protrusion 51, configured for locking of the plug 47 to the fluorescent tube bodies 13. The protrusion 51 engages beneath the curves 45 and secures the plug 47. The plug 47 is further configured with a T-shape, in which a transverse top bears against the top part 15 for insulation. The plug 47 is made of foamed silica. Silica (SiO2), which is a very good and stable insulator, is thus used for the plug 47.

A very large energy-saving potential is obtained by this material, which mostly consists of air and a little silica. The plug 47 gives greatly increased energy efficiency when this insulating material is used. The silica is transparent and tolerates more than 500° C. without change. The silica plug 47 can be cost-effectively cast into suitable shape, in which 3-5% is pure natural material, SiO2 (silica). The rest of the volume of the plug 47 is the air in the pores 49 (see FIG. 7c), which insulates.

FIG. 8 shows schematically the plug 47 shown in FIGS. 7a-7c. The plug 47 can be sold separately to a consumer (not shown). The consumer inserts the plug 47 between and into expedient traditional fluorescent tube bodies of a compact fluorescent tube. The compact fluorescent tube comprises at least one fluorescent tube body curved into a U-shape and forming two fluorescent tube body legs, each comprising a base part, enclosing a cathode chamber, and a top part 15 facing away from the said base parts fixed to a socket part. The plug 47 is thus configured to be able to be applied to the top part 15 of the compact fluorescent tube 1 for insulation of the compact fluorescent tube during its operation. In FIG. 9, a compact fluorescent tube 1 for cold spaces, comprising the plug 47 shown in FIG. 8, is shown schematically.

FIG. 10 shows schematically in perspective a compact fluorescent tube 1 for cold spaces according to a seventh embodiment. According to this embodiment, the insulating member is an insulating transparent gel 55 comprising microscopic cavities. During manufacture of the compact fluorescent tube 1, the gel 55 is applied directly to the fluorescent tube body 13 within the region of the top part 15.

FIG. 11 shows a cross section through two fluorescent tube bodies, together comprising four fluorescent tube body legs 17. A plastics film 59 enclosing the fluorescent tube body legs 17, within the region of the top part, forms an insulating cavity 61 in the gap between the fluorescent tube bodies within the region of the top part. The plastics film 59 is UV-resistant, heatproof and transparent.

The invention should not be deemed to be limited by the above-described embodiments, but rather there are also within the scope of the invention other embodiments which describe the inventive concept or combinations of the described embodiments. Of course, more fluorescent tube bodies than three can be used for the compact fluorescent tube 1 for cold spaces. Other materials for the insulating member and other structures for producing different types of cavities can be possible within the scope of the invention. For example, the number of hood halves can be three in number, or the plug can extend down over the outer side of the top part almost as far as the base part, forming an open space against the socket.

1. A compact fluorescent tube designed for cold spaces, the compact fluorescent tube comprising:
at least one fluorescent tube body formed into a U-shape and comprising two fluorescent tube body legs which latter have an interspace between them and each comprise a base part enclosing a cathode chamber, and a top part facing away from the said base parts,
wherein the base parts are fixed to a socket part comprising current feeder members for electrical contact with the cathode chambers, and
wherein an insulating member is arranged on the top part of the compact fluorescent tube and is configured with at least one insulating cavity, which, during operation of the compact fluorescent tube, is heated by the self-produced heat of the compact fluorescent tube.

2. The compact fluorescent tube according to claim 1, wherein the insulating member is constituted by a transparent hood enclosing the compact fluorescent tube so that a gap constituting the at least one insulating cavity is formed between the said fluorescent tube body and the transparent hood.

3. The compact fluorescent tube according to claim 2, wherein the transparent hood is made of plastic.

4. The compact fluorescent tube according to claim 2, wherein the transparent hood consists of at least two hood halves, each extending in the longitudinal direction of the fluorescent tube body legs and interconnected by at least one connecting element.

5. The compact fluorescent tube according to claim 1, wherein the insulating member extends towards the socket part to the extent that an open space is formed between the socket part and the insulating member.

6. The compact fluorescent tube according to claim 1, wherein a safety mantle made of insulating material extends between the insulating member and the socket part.

7. The compact fluorescent tube according to claim 1, wherein the insulating member is constituted by a plug having a plurality of the said insulating cavities, which plug, when the number of U-shaped fluorescent tube bodies is two or more, is insertable between the fluorescent tube bodies in the top part.

8. The compact fluorescent tube according to claim 7, wherein the plug is made of foamed silica.

9. The compact fluorescent tube according to claim 1, wherein the insulating member is an insulating transparent gel which has been applied directly to the fluorescent tube body within the region of the top part.

10. The compact fluorescent tube according to claim 1, wherein the insulating member comprises a connecting member for securing the insulating member to the fluorescent tube body via the said interspace.

11. An apparatus comprising:
an insulating member for a compact fluorescent tube, wherein the compact fluorescent tube comprises at least one fluorescent tube body curved into a U-shape and forming two fluorescent tube body legs, each comprising a base part, enclosing a cathode chamber, and a top part facing away from the said base parts fixed to a socket part,
wherein the insulating member is configured to be able to be applied to the top part of the compact fluorescent tube for insulation of the compact fluorescent tube during its operation.

12. The apparatus according to claim 11, wherein the insulating member is a transparent hood.

13. The apparatus according to claim 11, wherein the insulating member is constituted by a plug insertable in the top part.
